(19) United States
(12) Patent Application Publication
(10) Pub. No.: US 2002/0163525 A1
(43) Pub. Date: Nov. 7, 2002

(54) Method for enhancing saturation of color images

(76) Inventors: Shih-Pei Liao, Hsinchu (TW); Ying-Hui Liang, Hsinchu (TW); Chiung-Fen Lin, Hsinchu City (TW); Shu-Ru Liu, Hsinchu City (TW)

Correspondence Address: Jason Z. Lin, 19597 Via Monte Drive, Saratoga, CA, 95070, US

(21) Appl. No.: 09/802,036

(22) Filed: Mar. 7, 2001

(51) Int. Cl. G09G 5/02

(52) U.S. Cl. 345/589

(57) ABSTRACT

Saturation of a color is enhanced by moving a color point towards the boundary of a chromaticity diagram. An RGB color image is first converted to CIE format. The saturation of the color image is enhanced in the CIE color space by decreasing the content of white in the color image based on the chromaticity diagram. The saturation enhanced image is then transformed back to the RGB color space.

### FIELD OF THE INVENTION

The present invention generally relates to color image processing, and more specifically to a method of enhancing the saturation of color images.

### BACKGROUND OF THE INVENTION

Human eyes are stimulated by light passing through or reflected by an object to create a sense of brightness and color. The sensed signal is processed by the brain in order for people to recognize the object in terms of its brightness, hue and saturation. The light that creates the visual effect may comprise multiple wavelengths. Human eyes are able to determine the nearest color of the light from the spectra of red, orange, yellow, green, blue and purple.

Color is described as having three dimensions. These dimensions are hue, saturation, and brightness. Hue is the name of the color, which places the color in its correct position in the spectrum. Saturation refers to the degree of intensity in a color, or the strength of a color. A neutral gray is considered to have zero saturation. A saturated red would have a color similar to apple red. Pink is an example of an unsaturated red. Brightness describes differences in the intensity of light reflected from or transmitted by a color image.

The RGB space is a three-dimensional color space whose components are the red, green, and blue intensities that make up a given color. For example, scanners read the amounts of red, green, and blue light that are reflected from or transmitted through an image and then convert those amounts into digital values. Information displayed on a color monitor begins with digital values that are converted to analog signals for display on the monitor.

Any color expressed in RGB space is some mixture of three primary colors: red, green, and blue. Most RGB-based color spaces can be visualized as a cube, as shown in FIG. 1B, with comers of black, the three primaries (red, green, and blue), the three secondaries (cyan, magenta, and yellow), and white. It is frequently useful to separate the color definition into “luminance” and “chromaticity”. The CIE color system specifies chromaticity in such a way that all visible colors can be defined using only two positive values and a luminance value as shown in FIG. 1A, with luminance being normal to the diagram.

Every color can be formed by mixing red, green and blue. The mixed color is determined by the ratios among red, green and blue. For a display capable of showing 256 levels for each basic color, the total possible number of colors displayed can be 16,777,216. A human eye can not distinguish colors of such fine resolution. To a person, many different colors look similar. However, the brightness and saturation between two different colors can be distinguished. Therefore, the degree of saturation is a critical factor for the quality of an image display product. In general, a higher degree of saturation makes a color look vivid. Many image displaying or processing products are judged by the degree of saturation in the displayed color.

### SUMMARY OF THE INVENTION

This invention has been made to meet the need of enhancing the saturation of color in order to improve the quality of an image display product. According to the invention, a color point in an RGB color image is first converted into its CIE format. The triangular formed by pure white and other two primary colors on the chromaticity diagram in the CIE color model to enclose the color point is determined. The saturation of the color point is then adjusted by moving the color point along the line formed by the pure white and the color towards the line formed by the two primary colors on the chromaticity diagram. The saturation enhanced color in CIE format is then transformed back to the RGB color model. After saturation enhancement, the brightness of the color is adjusted.

The foregoing features, aspects and advantages of the present invention will become better understood from a careful reading of a detailed description provided herein below with appropriate reference to the accompanying drawings.

### BRIEF DESCRIPTION OF THE DRAWINGS

FIG. 1A illustrates a conventional CIE color model.

FIG. 1B illustrates a conventional RGB color model.

FIG. 2 shows the flow chart of the method for enhancing saturation of color according to the present invention.

FIG. 3 illustrates geometrically how the saturation of a color point in CIE model is increased according to the present invention.

### DETAILED DESCRIPTION OF THE INVENTION

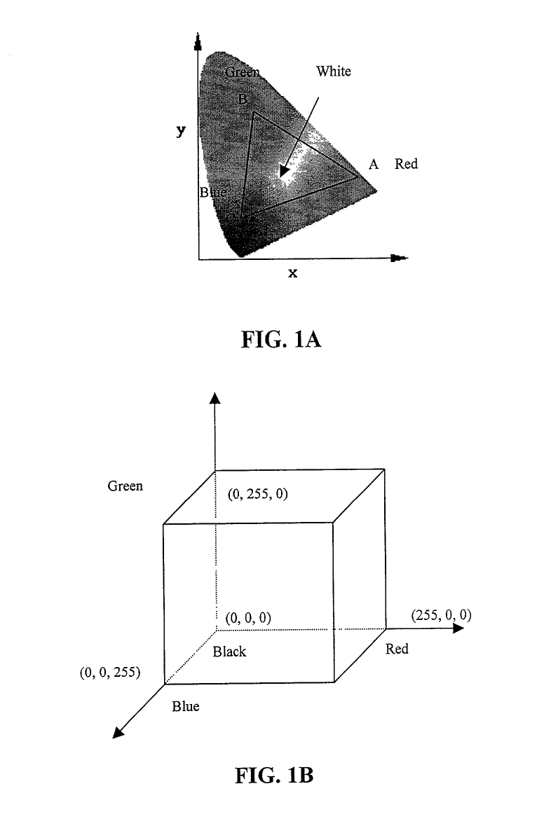

A color model is a specification of a 3-D coordinate system in which each color is represented by a single point. In the RGB color model, each color is composed by the three primary colors, i.e., red, green and blue. The RGB color model is based on a Cartesian coordinate system. The color subspace of interest is the cube shown in FIG. 1 B.

The RGB color model can be represented by a subspace shown in FIG. 1A when it is transformed into the CIE color model. In the RGB model of FIG. 1B, coordinate (255, 255, 255) represents pure white, and the coordinates (255, 0, 0), (0, 255, 0) and (0, 0, 255) represent red, green and blue colors respectively. These color points can be transformed to points O (0.313, 0.329), A (0.64, 0.33), B (0.3, 0.6) and C (0.15, 0.06) in the CIE color model as shown in FIG. 1A. Therefore, the space formed by O, A, B and C in the CIE color model of FIG. 1A corresponds to the cube in the RGB model of FIG. 1B.

In the chromaticity diagram of CIE model, the point of equal energy corresponds to equal fractions of three primary colors and represents the CIE standard white. Any point located on the boundary of the chromaticity diagram is said to be completely saturated. As a point leaves the boundary and approaches the point of equal energy, more white light is added to the color and it becomes less saturated. Therefore, the saturation of a color can be enhanced by moving a color point towards the boundary of the chromaticity diagram.

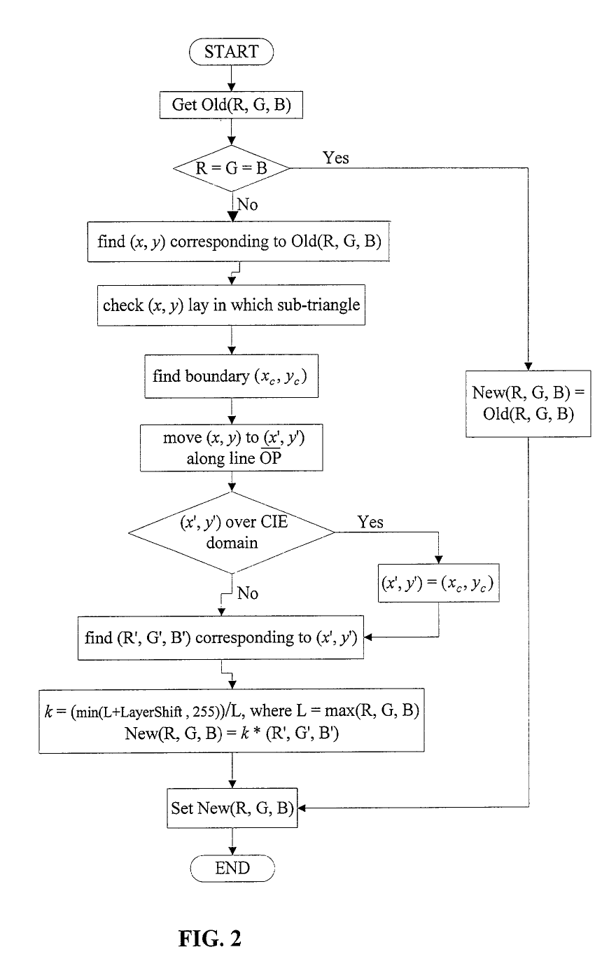

The invention provides a method of enhancing the saturation of color images. An RGB color image is first converted to the CIE format. The saturation of the image is then adjusted in the CIE color space. Finally, the saturation-enhanced image is transformed back to the RGB color space. FIG. 2 shows the flow chart of the method according to the invention.

As shown in FIG. 2, an image pixel is represented with a color point (r, g, b) in the RGB color model. The method of this invention first determines if the saturation can be enhanced or not. If it is found that r=g=b, no enhancement of the saturation needs to be done. As shown in the flow chart, the method ends without changing its hue and saturation in this case. Otherwise, the (x, y) coordinate in the CIE color model is determined from the RGB color model by the following formula:

x=X/(X+Y+Z)

y=Y/(X+Y+Z)

where

X=r·Xᵣ+g·X_{g}+b·X_{b}

Y=r·Yᵣ+g·Y_{g}+b·Y_{b}

X=r·Zᵣ+g·Z_{g}+b·Z_{b}

and

Xᵣ=0.412, X_{g}=0.358, X_{b}=0.180

Yᵣ=0.213, Y_{g}=0.715, Y_{b}=0.072

Zᵣ=0.019, Z_{g}=0.119, Z_{b}=0.950

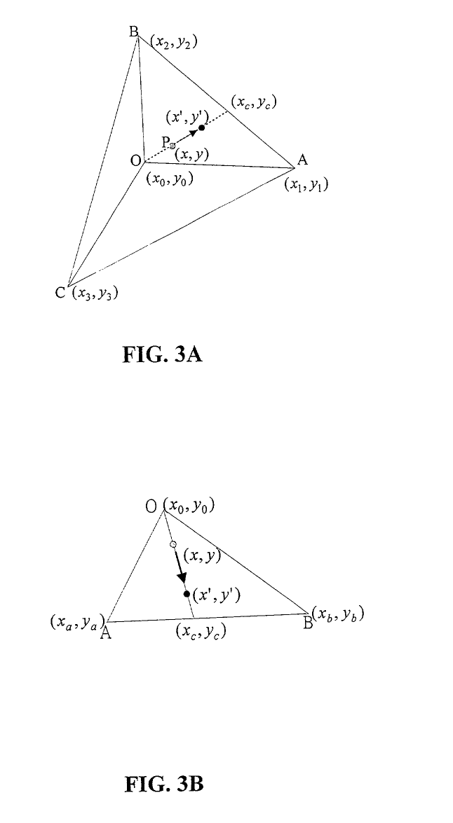

As shown in FIG. 3A, three triangular areas OBC, OAB and OAC are formed by the four points O, A, B and C in the CIE color model. The next step is to determine at which triangular area the color point (x, y) is located. This can be accomplished by substituting (x, y) into equations of the three lines formed by OA, OB and OC. The following step is to determine the intersection point (x_{c}, y_{c}) between the side of the triangular which is opposite to O and the line formed by O and the color point (x, y) as shown in FIG. 3B. Assuming that (x, y) is located within the triangular OAB, (x_{c}, y_{c}) can be computed as follows:

a₁=y−y₀; b₁=x₀−x; c₁=(y−y₀)x₀+(x₀−x)y₀

a₂=yₐ−y_{b}; b₂=x_{b}−xₐ; c₂=(yₐ−y_{b})x_{b}+(x_{b}−xₐ)y_{b}

$${x}_{c} = \frac{{b}_{2} {c}_{1} - {b}_{1} {c}_{2}}{{b}_{2} {a}_{1} - {b}_{1} {a}_{2}} ; {y}_{c} = \frac{{a}_{2} {c}_{1} - {a}_{1} {c}_{2}}{{a}_{2} {b}_{1} - {a}_{1} {b}_{2}}$$

where (x₀, y₀), (xₐ, yₐ), (x_{b}, y_{b}) are the coordinates of O, A and B respectively.

According to this invention, the saturation of the color is enhanced by moving the color point (x, y) towards the triangular side AB as illustrated in FIG. 3B. A parameter s is used as the parameter for adjusting the saturation. The color point (x′, y′) after the adjustment can be expressed as

$${x}^{′} = x + \frac{x - {x}_{0}}{\sqrt{{( x - {x}_{0} )}^{2} + {( y - {y}_{0} )}^{2}}} \cdot s$$

$${y}^{′} = y + \frac{y - {y}_{0}}{\sqrt{{( x - {x}_{0} )}^{2} + {( y - {y}_{0} )}^{2}}} \cdot s ,$$

where the parameter s is determined by the user. If (x′, y′) is moved outside the triangular area in the CIE color model after the adjustment, it is set back to the intersection point (x_{c}, y_{c}).

The color point (x′, y′) is then transformed back to the RGB color model. From the conversion equations of CIE model to RGB mode:

r′=3.241·X′−1.537·Y′−0.499·Z′

g′=−0.969·X′+1.876·Y′+0.042·Z′

b′=0.056·X′−0.204·Y′+1.057·Z′

with x′=X′/(X′+Y′+Z′) and y′=Y′/(X′+Y′+Z′), where (r′, g′, b′) is the saturation enhanced color point of the original color point (r, g, b). One can set X′=x′·t, Y′=y′·t and Z′=(1−x′−y′)·t to rewrite the conversion equations as

r′=[3.241·x′−1.537·y′−0.499·(1−x′−y′)]·t

g′=[−0.969·x′+1.876·y′+0.042·(1−x′−y′)]·t

b′=[0.056·x′−0.204·y′+1.057·(1−x′−y′)]·t

where t is determined by matching the largest values in (r′, g′, b′) and (r, g, b).

Finally, the brightness of the saturation enhanced color point can be increased by the following formula:

(r″, g″, b″)=(r′, g′, b′)*k,

where k=min {(L+layer-shift), 255}/L is determined by the largest value L of r, g, and b, and layer-shift is the adjustment parameter for the brightness. The adjustment parameter is determined by the user.

The above method will be illustrated with the following example. The color point in assumed to be (72, 81, 178) in the RGB model. The (x, y) coordinate in the CIE color model is determined as:

X=0.412*72+0.358*81+0.180*178=90.779

Y=0.213*72+0.358*81+0.072*178=86.088

Z=0.019*72+0.119*81+0.950*178=180.216

x=X/(X+Y+Z)=90.779/(90.779+86.088+180.216)=0.254

y=Y/(X+Y+Z)=86.088/(90.779+86.088+180.216)=0.241.

Therefore, the coordinate (x, y) in the CIE color model corresponding to the color point (72, 81, 178) is computed to be (0.254, 0.241).

With reference to FIG. 3A, lines OA, OB and OC can be expressed the following equations:

(OA): 0.0006x−0.3282y+0.1078=0,

(OB): 0.2713x+0.0128y−0.0890=0,

(OC): 0.2691x−0,1628y−0.0306=0.

By substituting (0.254, 0.241) of this example into the equations, it can be determined that (0.254, 0.241) is located within the triangular OBC because

0.0006x−0.3282y+0.1078>0,

0.2713x+0.0128y−0.0890<0,

0.2691x−0,1628y−0.0306<0,

with x=0.254 and y=0.241.

The side of the triangular opposite to O can be represented by the line formed by the two points B (0.3, 0.6) and C (0.15, 0.06). The line formed by O (0.313, 0.329) and the color point (0.254, 0.241) intersects with the triangular side at (x_{c}, y_{c}). Assuming

a₁=y−0.329

b₁=0.313−x,

c₁=(y−0.329)*0.313+(0.313−x)*0.241−0.329,

a₂=0.600−0.060,

b₂=0.150−0.300,

c₂=(0.600−0.060)*0.150+(0.150−0.3)*0.060,

and using the formula

$${x}_{c} = \frac{{b}_{2} {c}_{1} - {b}_{1} {c}_{2}}{{b}_{2} {a}_{1} - {b}_{1} {a}_{2}} and {y}_{c} = \frac{{a}_{2} {c}_{1} - {a}_{1} {c}_{2}}{{a}_{2} {b}_{1} - {a}_{1} {b}_{2}} ,$$

the intersection point (x_{c}, y_{c}) can be determined as (0.162, 0.102) by substituting x=0.254 and y=0.241 into the above equations.

As described before, the saturation of the color is enhanced by moving the color point (x, y) towards the triangular side BC which is opposite to O. A parameter s is used as the parameter for adjusting the saturation. The color point (x′, y′) after the adjustment can be expressed as

x′=x+[(x−x₀)/[(x−x₀)²+(y−y₀)²]^{½}]·s

y′=y+[(y−y₀)/[(x−x₀)²+(y−y₀)²]^{½}]·s,

where the parameter s is determined by the user. By using a parameter s=0.04, the adjusted color point (x′, y′) is (0.232, 0.207) in the above example.

The color point (x′, y′) is then transformed back to the RGB color model according to the following formula:

r′=[3.241x′−1.537y′−0.499(1−x′−y′)]*t

g′=[−0.969x′+1.876y′+0.042(1−x′−y′)]*t,

b′=[0.056x′−0.204y′+1.057(1−x′−y′)]*t,

where (r′, g′, b′) is the saturation enhanced color point of the original color point (r, g, b) and t is determined by matching the largest values in (r′, g′, b′) and (r, g, b). For the above example, the saturation enhanced color point in the CIE color model for the RGB color point (72, 81, 178) has been calculated to be (0.232, 0.207). Because b=178 is the largest value in (r, g, b), b′ is set to 178. By substituting x=0.232, y=0.207 and b′=178 into the above formula, t can be found to be 316.340. r′ and g′ can then be calculated to be 48 and 59 respectively. Consequently, it is determined that the saturation enhanced RGB color point is (48, 59, 178). In this example, the brightness of the saturation enhanced color point is increased with a layer-shift 15 and, hence, k=(178+15)/178=1.084. The saturation enhanced color point after brightness adjustment becomes (r″, g″, b″)=(48, 59, 178)*1.084=(52, 63, 193).

According to this invention, the method for enhancing saturation can be accomplished with a program that may be implemented with image processing software or realized with hardware circuit. The method can be used in any hardware or software product related to images such as image displays or scanners. It may also be used in optical gadget such as projectors, cameras or camcorders.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of enhancing saturation of color images, comprising the steps of:
(a) converting a color point (r, g, b) in RGB color model to a color point (x, y) in CIE color model;
(b) forming a line from a white point (x₀, y₀) in CIE color model towards said color point (x, y), said white point (x₀, y₀) corresponding to (255, 255, 255) in RGB color model;
(c) selecting a saturation enhanced color point (x′, y′) on said line, said color point (x, y) being between said saturation enhanced color point (x′, y′) and said white point (x₀, y₀) in CIE color model; and
(d) converting said saturation enhanced color point (x′, y′) to a saturation enhanced color point (r′, g′, b′) in RGB color model.

2. The method as claimed in claim 1, further comprising the step of:
(e) adjusting said saturation enhanced color point (r′, g′, b′) by a parameter k to form a brightness adjusted and saturation enhanced color point (kr′, kg′, gb′), said parameter k being determined by the largest value in r, g and b.

3. The method as claimed in claim 1, (x, y) being computed in said step (a) according to:
x=X/(X+Y+Z)
y=Y/(X+Y+Z)
wherein
X=0.412·r+0.358·g+0.180·b
Y=0.213·r+0.715·g+0.072·b
X=0.019·r+0.119·g+0.950·b.

4. The method as claimed in claim 1, said step (c) further comprising the steps of:
(c1) selecting two boundary color points from three primary color points in CIE model, said two boundary color points and said white point forming a triangular enclosing said color point (x, y), said three primary color points being (255, 0, 0), (0, 255, 0) and (0, 0, 255) in RGB color model;
(c2) determining a boundary color point (x_{c}, y_{c}) where said line formed by said white point (x₀, y₀) and (x, y) intersects with a boundary line formed by said two boundary color points; and
(c3) setting (x′, y′)=(x_{c}, y_{c}) if (x_{c}, y_{c}) is located between (x, y) and (x′, y′).

5. The method as claimed in claim 1, (x′, y′) being computed in said step (c) according to:
$${x}^{′} = x + \frac{x - {x}_{0}}{\sqrt{{( x - {x}_{0} )}^{2} + {( y - {y}_{0} )}^{2}}} \cdot s$$
$${y}^{′} = y + \frac{y - {y}_{0}}{\sqrt{{( x - {x}_{0} )}^{2} + {( y - {y}_{0} )}^{2}}} \cdot s ,$$
wherein s is a parameter for enhancing saturation of said color point (x, y).

6. The method as claimed in claim 1, (r′, g′, b′) being computed in said step (d) according to:
r′=[3.241x′−1.537y′−0.499(1−x′−y′)]*t,
g′=[−0.969x′+1.876y′+0.042(1−x′−y′)]*t,
b′=[0.056x′−0.204y′+1.057(1−x′−y′)]*t,
wherein t is a parameter determined by the largest value in r, g and b.
